(19) United States
(12) Patent Application Publication
(10) Pub. No.: US 2024/0299905 A1
(43) Pub. Date: Sep. 12, 2024

(54) POST-SYNTHETIC FUNCTIONALIZATION OF POROUS MATERIALS

(71) Applicant: Mosaic Materials, Inc., Alameda, CA (US)

(72) Inventors: Graham B. Wenz, Richmond, CA (US); Michael A. Boreen, Berkeley, CA (US); Aeri J. Gosselin, El Cerrito, CA (US); Richard P. Reimer, Redwood City, CA (US)

(21) Appl. No.: 18/182,089

(22) Filed: Mar. 10, 2023

(51) Int. Cl. B01J 20/22; B01J 20/32; C07F 3/02

(52) U.S. Cl. CPC B01J 20/226; B01J 20/3206; B01J 20/3221; B01J 20/3248; C07F 3/02

(57) ABSTRACT

A process of manufacturing a functionalized porous material includes: mixing a base porous material comprising a porous structure and a labile ligand with a functionalizing agent to form a slurry, the porous structure having open metal sites and a plurality of pores, wherein the labile ligand is coordinated to the open metal sites, present in the plurality of pores but not coordinated to the open metal sites, or a combination thereof, the labile ligand has a first boiling temperature and the functionalizing agent has a second boiling temperature that is higher than the first boiling temperature; and drying the slurry to form a functionalized porous material comprising the functionalizing agent coordinated to the open metal sites.

### STATEMENT OF GOVERNMENT SUPPORT

This invention was made in part with government support from the U.S. Department of Energy's Office of Energy Efficiency and Renewable Energy (EERE) under the Advanced Manufacturing Office (AMO) Award Number DE-EE0009419. The government has certain rights in this invention.

### BACKGROUND

This disclosure is directed to post-synthetic functionalization of porous materials, and in particular post-synthetic functionalization of metal-organic frameworks having open metal sites.

Metal-organic frameworks (MOFs) are three-dimensional crystalline networks containing potential pores. MOFs are currently attracting considerable attention largely due to their potential use in CO₂ capture, gas separation and storage, catalysis, and drug delivery. MOFs are normally formed by linking together metal ions or metal clusters (often referred to as secondary building units) with organic linkers.

Functionalizing MOFs can improve their performance in various applications, for example increase the gas uptake or catalytic activity. Accordingly, there has been an increasing shift towards increased MOF functionality. Functionalized MOFs can be prepared by in situ functionalization, where functional groups are introduced during the solvothermal process to synthesize the MOFs. MOFs can also be functionalized via post-synthetic modification. As used herein, post-synthetic modification means a modification of a MOF material after its synthesis or after the three-dimensional extended framework of a MOF has been established. A post-synthetic approach can enable the incorporation of functional groups into MOFs that otherwise would not survive MOF synthesis, due to temperature, pH, or other reaction conditions. Despite the advances in the art, there is a continuing need for processes of functionalizing porous materials with improved efficiency.

### SUMMARY

A process of manufacturing a functionalized porous material includes: mixing a base porous material comprising a porous structure and a labile ligand with a functionalizing agent to form a slurry, the porous structure having open metal sites and a plurality of pores, wherein the labile ligand is coordinated to the open metal sites, present in the plurality of pores but not coordinated to the open metal sites, or a combination thereof, the labile ligand has a first boiling temperature and the functionalizing agent has a second boiling temperature that is higher than the first boiling temperature; and drying the slurry to form a functionalized porous material comprising the functionalizing agent coordinated to the open metal sites.

### BRIEF DESCRIPTION OF THE DRAWINGS

A description of the figures, which are meant to be exemplary and not limiting, is provided in which:

FIG. 1 illustrates a process of functionalizing a base porous material having open metal sites via a post-synthetic ligand exchange according to an embodiment of the disclosure; and

FIG. 2 illustrates a process of manufacturing a functionalized porous material where the process includes preparing a base porous material having open metal sites; and functionalizing the base porous material via a post-synthetic ligand exchange.

### DETAILED DESCRIPTION

A detailed description of one or more embodiments is presented herein by way of exemplification and not limitation.

Porous materials, for example, MOFs, often have open metal sites. As used herein, the term “open metal sites” refers to not fully coordinated metal ions. Open metal sites can also be referred to as coordinatively unsaturated sites.

A process of functionalizing porous materials having open metal sites can involve the use of organic solvents both as a solvent for the functionalization to take place and for subsequent washing and purification steps. However, very polar solvents, such as N,N-dimethylformamide or methanol, which are typically used in the art as solvents for the synthesis of MOFs, are often incompatible with this process. These solvents, in high concentration relative to the functionalizing agent, can out-compete the functionalizing agent for coordination to the open metal sites, leading to incomplete functionalization of the porous material. Accordingly, it is typical that very polar solvents must be removed from the MOFs, either by temperature/vacuum removal or subsequently washed with less polar solvents, such as acetonitrile, hexanes, or toluene, before the MOFs can be functionalized.

The inventors hereof have discovered a new process of functionalizing a porous material where functionalization is achieved via a post-synthetic ligand exchange within a porous material having open metal sites. In the process, the open metal sites within the porous material are first populated by labile ligands after or during the synthesis of the porous material, then these labile ligands are replaced with functionalizing agents that form adducts with the open metal sites.

The process as described herein enables use of ligands having higher boiling points than polar solvents (labile ligands) for functionalization. It is particularly advantageous to be able to use water as the labile ligand for this process. As the process can obviate the need for any organic solvents, the process has reduced manufacturing cost and reduced waste, which is particularly beneficial when the process is carried out at a large scale in a commercial setting. Additionally, this process eliminates multiple steps, because the functionalized porous material can be formed and dried at the same time from a slurry of the functionalizing agent and the porous material populated with the labile ligands, without the need for further filtration and washing.

The functionalized porous material prepared by the process as disclosed herein can have comparable performance as the functionalized porous materials prepared via known processes. Without wishing to be bound by theory, it is believed that the process as disclosed herein allows for the functionalization of the porous material without damaging its framework. Illustratively, the crystallinity and the porosity of the porous material can be preserved after functionalization.

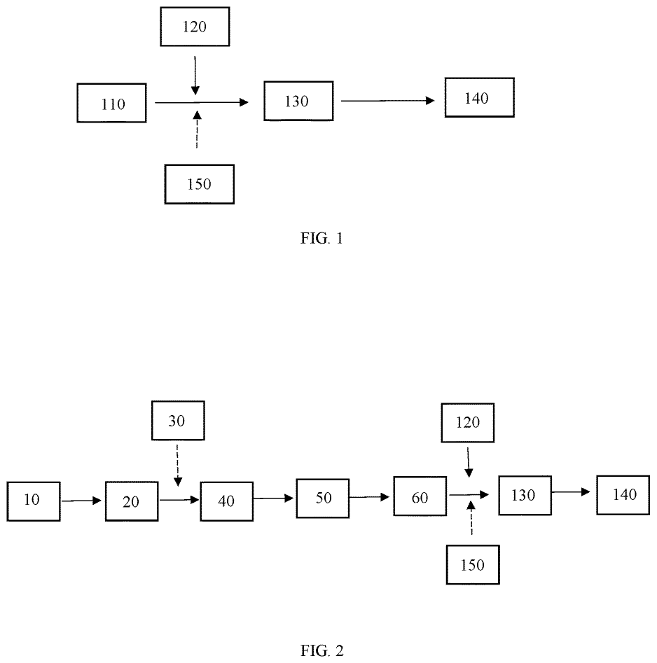

Referring to FIG. 1, a process of manufacturing a functionalized porous material (140) comprises mixing a base porous material (110) with a functionalizing agent (120) to form a slurry (130); and drying the slurry to form the functionalized porous material (140). Optionally, a slurry solvent (150) is added and mixed with the base porous material (110) and the functionalizing agent (120) to form the slurry (130).

The base porous material (110) comprises a porous structure and a labile ligand. The porous structure has open metal sites and a plurality of pores, and is the framework of the base porous material. Preferably, the porous structure can be a MOF. MOFs include inorganic nodes connected by organic linkers.

The inorganic nodes comprise open metal sites. The open metal sites can be ions of least one of Mg, Ca, Ba, Al, Sc, Zr, V, Cr, Mn, Fe, Co, Ni, Cu, Zn, Ti, Cd, or Eu, preferably the ions of at least one of Mg, Mn, Zn, or Ni. The organic linkers can comprise at least one of a carboxylate, a triazolate, or an imidazolate, preferably a carboxylate. Examples of the organic linkers include, but are not limited to, 4,4′-dihydroxy-(1,1′-biphenyl)-3,3′-dicarboxylate, 2,5-dihydroxybenzene-1,4-dicarboxylate, 4,6-dihydroxybenzene-1,3-dicarboxylate, benzene-1,4-dicarboxylate, benzene-1,3,5-tricarboxylate, 3,3′,4,4′-benzophenone-tetracarboxylate, benzene-1,2,4,5-tetracarboxylate, trans-1,4-cyclohexanedicarboxylate, 1H,7H-[1,4]dioxino[2,3-F:5,6-F′]bisbenzotriazolate, 1,5-dihydrobenzo[1,2-d:4,5-d′]bis([1,2,3]triazolate, 3,5-dimethyl-1H-pyrazole-4-carboxylate, 5-(pyridin-3-yl)benzene-1,3-dicarboxylate, 1,3,5-tri(1H-tetrazol-5-yl) benzene, 2-methylimidazolate, 2-ethylimidazolate, and 1-benzyl-1H-imidazolate. Other suitable known organic linkers can also be used. Preferably the organic linkers comprise 4,4′-dihydroxy-(1,1′-biphenyl)-3,3′-dicarboxylate.

Examples of the MOFs having open metal sites include, but are not limited to, MOF-74, MOF-274, HKUST-1, MII-100, MIL-101, MOF-525, MOF-2, MOF-505, and UiO-66. Additional MOFs include but are not limited to those described in Chem. Soc. Rev. 2020, 49, 2751-2798. A preferred MOF is Mg₂(dobpdc) where the inorganic nodes comprise Mg ions and the organic linkers comprise 4,4′-dihydroxy-(1,1′-biphenyl)-3,3′-dicarboxylate (dobpdc).

As used herein, a labile ligand refers to a ligand that can initially coordinate to the open metal sites of the porous structure but later be replaced by a functionalizing agent. The labile ligand has oxygen and/or nitrogen atoms, and can be used as a solvent for the synthesis of the porous structure or for the purification/washing of the porous structure. Examples of the labile ligand include, but are not limited to, water, methanol, ethanol, acetonitrile, and N,N-dimethylformamide. The base porous material can include more than one labile ligand. In an aspect, greater than 50 wt %, greater than 70 wt %, greater than 80 wt %, greater than 90 wt %, greater than 95 wt %, or 100 wt % of the labile ligand in the base porous material is water, based on a total weight of the labile ligand in the base porous material. In another aspect, greater than 50 wt %, greater than 70 wt %, greater than 80 wt %, greater than 90 wt %, greater than 95 wt %, or 100 wt % of the labile ligand in the base porous material is methanol, ethanol, or a combination thereof, based on a total weight of the labile ligand in the base porous material.

The labile ligand is coordinated to the open metal sites, present in the plurality of the pores but not coordinated to the open metal sites, or a combination thereof. A weight ratio of the labile ligand to the porous structure in the base porous material can be about 25:1 to about 1:0.5, about 25:1 to about 1:1, about 20:1 to about 3:1, about 15:1 to about 5:1, or about 10:1 to about 7:1.

The base porous material can be mixed with a labile ligand and a functionalizing agent to form a slurry. The functionalizing agent is capable of replacing the labile ligand and coordinating to the open metal sites. A suitable functionalizing agent has a boiling point higher than that of the labile ligand. In particular, the labile ligand has a first boiling temperature, and the functionalizing agent has a second boiling temperature that is higher than the first boiling temperature. In an aspect, the functionalizing agent has a boiling temperature of about 70° C. to about 340° C., preferably about 120° C. to about 200° C. The difference between the second boiling temperature and the first boiling temperature can be about 50° C. to about 150° C., or about 60° C. to about 120° C.

Examples of the functionalizing agents include, but are not limited to, monoamines; diamines such as primary/primary diamines, primary/secondary diamines, primary/tertiary diamines, and secondary/secondary diamines; bifunctional ligands; and polyamines such as triamines, tetramines, and aminopolymers.

The monoamines can be monoalkylamines, dialkylamines, trialkylamines, monoarylamines, diarylamines, triarylamines, and mixed alkyl-aryl-amines. Examples of the monoamines include, but are not limited to, aniline, n-butylamine, n-pentylamine, n-hexylamine, diphenylamine, and triethylamine.

Examples of the diamines include, but are not limited to, ethylene diamine, 2,2-dimethyl-1,3-propanediamine, 1,3-diaminopentane, 2-methylpropane-1,2-diamine, N-ethylethylenediamine, N-isopropylethylenediamine, N-butylethylenediamine, N-pentylethylenediamine. N-hexylethylenediamine, N,N-dimethylethane-1,2-diamine, N,N-diethylethylenediamine, N,N-diisopropylethylene diamine, N,N-dimethylpropylenediamine, N,N′-dimethylethane-1,2-diamine, 2-(aminomethyl)piperidine, and N,N-diethyl-N-methylethylenediamine.

As used herein, a bifunctional ligand refers to a single organic molecule having two different functional groups. Examples of the bifunctional ligands include, but are not limited to, amino-alcohols (also known as alkanolamines).

Suitable polyamines include, but are not limited to, bis(3-aminopropyl)amine, N,N′-bis(3-aminopropyl)-1,4-butanediamine, tetraethylene pentaamine, polyethyleneimine, and polypropyleneimine. Preferably, the functionalizing agent includes a primary/secondary diamine disclosed herein.

A molar ratio of the functionalizing agent relative to the open metal sites in the porous structure is at least 1 to achieve 100% coverage of open metal sites. Depending on the conditions, some functionalizing agent may evaporate along with labile ligand during the drying process. In this instance, a slight excess of functionalizing ligand can be used. In general, a molar ratio of the functionalizing agent relative to the open metal sites can be from about 3:1 to about 1:1, from about 2:1 to about 1:1, from about 1.8:1 to about 1.2:1, or about 1.5.

Mixing is performed before drying and is generally carried out for just longer than the amount of time required to achieve a uniform consistency for the resulting slurry. Better results can be observed for uniform slurries versus non-uniform mixtures. At a minimum, this could be achieved in 5 minutes, but extended mixing of the slurry for 90 minutes also yields good results. The mixing can be conducted at room temperature (23° C.) and atmospheric pressure. However, the mixing can also be conducted at an elevated temperature, for example, at a temperature that is greater than 23° C. but less than 50° C. In an aspect, a slurry solvent is optionally added during mixing to prepare the slurry. Advantageously, no solvent needs to be added. If used, the slurry solvent can comprise the labile ligand as described herein. In an aspect, the slurry solvent, if used, includes greater than 50 wt %, greater than 70 wt %, greater than 80 wt %, greater than 90 wt %, greater than 95 wt %, or 100 wt % of water based on a total weight of the slurry solvent. In another aspect, the slurry solvent includes greater than 50 wt %, greater than 70 wt %, greater than 80 wt %, greater than 90 wt %, greater than 95 wt %, or 100 wt % of methanol, ethanol, or a combination thereof based on a total weight of the slurry solvent.

During the drying process, temperatures from 20° C. to 150° C. 23° C. to 110° C., 40° C. to 110° C., or 60° C. to 100° C. can be applied to the slurry to form the functionalized porous material. Temperature affects the amount of time required to remove the labile ligand and to form the dried functionalized product, with higher temperature causing faster drying. In an aspect, temperatures between about 70° C. and 90° C. or around 80° C. can be applied, as this could be conveniently and safely reached using a water bath in a rotary evaporator and led to rapid drying rates.

Pressures from atmospheric pressure (101,325 pascals) down to 100 pascals, for example about 15,000 pascals to about 100 pascals, can be applied and all resulted in suitably functionalized material. Lower pressures cause faster removal of the labile ligand. Preferably, the strongest vacuum that can be applied with the given equipment without causing bumping (bubbling of the material up into the body of the drying apparatus) is used.

Any equipment capable of applying temperature and vacuum are suitable for the drying process. In the extreme case, the slurry can be left to dry (if labile ligand satisfies the criteria to evaporate at atmospheric conditions) at room temperature and pressure and result in suitably functionalized material.

When the porous structure is a MOF, the base porous material can be prepared by a reaction of a metal salt with an organic bridging ligand in the presence of a reaction solvent. The metal salt can be a salt of at least one of Mg, Ca, Ba, Al, Sc, Zr, V, Cr, Mn, Fe, Co, Ni, Cu, Zn, Ti, Cd, or Eu. The salt can be an acetate, a hydroxide, a carbonate, a nitrate, a chloride, a sulfate, or a combination thereof.

The organic bridging ligand can be at least one of a carboxylic acid, a triazole, or an imidazole, preferably, a carboxylic acid. Examples of the organic bridging ligand, include, but are not limited to, 4,4′-dihydroxy-(1,1′-biphenyl)-3,3′-dicarboxylic acid, 2,5-dihydroxybenzene-1,4-dicarboxylic acid, 4,6-dihydroxybenzene-1,3-dicarboxylic acid, benzene-1,4-dicarboxylic acid, benzene-1,3,5-tricarboxylic acid, 3,3′,4,4′-benzophenone-tetracarboxylic acid, benzene-1,2,4,5-tetracarboxylic acid, trans-1,4-cyclohexanedicarboxylic acid, 1H,7H-[1,4]dioxino[2,3-F:5,6-F′]bisbenzotriazole, 1,5-dihydrobenzo[1,2-d:4,5-d′]bis([1,2,3]triazole, 3,5-dimethyl-1H-pyrazole-4-carboxylic acid, 5-(pyridin-3-yl)benzene-1,3-dicarboxylic acid, 1,3,5-tri(1H-tetrazol-5-yl) benzene, 2-methylimidazole, 2-ethylimidazole, and 1-benzyl-1H-imidazole. Other suitable known organic bridging ligands can also be used. More than one organic bridging ligand can be used.

The reaction solvent can include the labile ligand, such as water, methanol, ethanol, acetonitrile, N,N-dimethylformamide, or a combination thereof. Preferably the reaction solvent comprises greater than 50 wt %, greater than 70 wt %, greater than 80 wt %, greater than 90 wt %, greater than 95 wt %, or 100 wt % of water, based on a total weight of the reaction solvent.

The reaction can be conducted at a temperature of about 50° C. to about 120° C., or about 60° C. to about 100° C., or under reflex for a period of about 10 minutes to about 24 hours depending on the specific reactants used. A base may be present during the reaction. The reaction can be conducted at an atmospheric pressure to provide a crude reaction product.

Once the reaction is complete, the reaction can be quenched by cooling down the reaction mixture. Water, preferably chilled water, can be added to the reaction mixture to quench the reaction.

The quenched product comprises the base porous material, and the base porous material can be separated from the quenched product by filtration. The filtered solid can be washed or rinsed with a rinsing solvent to remove unreacted starting materials or byproducts if any. The rinsing solvent can comprise the labile ligand such as water, methanol, ethanol, acetonitrile, N,N-dimethylformamide, or a combination thereof. For example, the rinsing solvent can contain greater than 50 wt %, greater than 70 wt %, greater than 80 wt %, greater than 90 wt %, greater than 95 wt %, or 100 wt % of water, based on a total weight of the rinsing solvent. Alternatively, the rinsing solvent can contain greater than 50 wt %, greater than 70 wt %, greater than 80 wt %, greater than 90 wt %, greater than 95 wt %, or 100 wt % of methanol, ethanol, or a combination thereof, based on a total weight of the rinsing solvent. The product is usually obtained in the form of a wet filter cake as a result of using a filter plate press machine.

Referring to FIG. 2, a process of manufacturing a functionalized porous material (140) comprises (a) a reaction of (10) a metal salt with an organic bridging ligand in the presence of a reaction solvent comprising the labile ligand to form a crude product (20); (b) addition of water and/or other labile ligand (30) to the crude product (20) to obtain a quenched product (40); (c) filtration of the quenched product (40) to obtain a filter cake (50); (d) rinsing of the filter cake (50) to obtain a rinsed filter cake (60) comprising the base porous material; (e) mixing of the rinsed filter cake (60) with the functionalizing agent (120) and optionally a slurry solvent (150) to form a slurry (130); and (f) drying of the slurry (130) to form the functionalized porous material (140). The “other labile ligand” (30) can be the same or different from the labile ligand in the reaction solvent.

As a specific example, a process of manufacturing a functionalized porous material comprises (a) a reaction of a magnesium salt with 4,4′-dihydroxy-(1,1′-biphenyl)-3,3′-dicarboxylic acid in the presence of a reaction solvent comprising greater than 50 wt %, greater than 70 wt %, greater than 80 wt %, greater than 90 wt %, greater than 95 wt %, or 100 wt % of water based on a total weight of the reaction solvent to form a crude product; (b) addition of a labile ligand such as water to the crude product to obtain a quenched product; (c) filtration of the quenched product to obtain a filter cake; (d) rinsing of the filter cake with a rinsing solvent comprising greater than 50 wt %, greater than 70 wt %, greater than 80 wt %, greater than 90 wt %, greater than 95 wt %, or 100 wt % of water based on a total weight of the rinsing solvent to obtain a rinsed filter cake comprising the base porous material; (e) mixing of the rinsed filter cake with the functionalizing agent and optionally a slurry solvent comprising greater than 50 wt %, greater than 70 wt %, greater than 80 wt %, greater than 90 wt %, greater than 95 wt %, or 100 wt % of water based on a total weight of the slurry solvent to form a slurry; and (f) drying of the slurry at a temperature of about 20° C. to about 150° C., preferably about 40 C to about 110° C., and a pressure of about 101,325 pascals to about 1,200 pascals, preferably about 15,000 pascals to about 1,200 pascals, to form the functionalized porous material comprising the functionalizing agent.

Advantageously, no further purification is needed after the drying process. The functionalized porous material prepared from the process described herein can have less than 40 wt %, less than 30 wt %, less than 20 wt %, 10 wt %, less than 5 wt %, less than 2 wt %, or less than 1 wt % of the labile ligand, based on a total weight of the functionalized porous material. In an aspect, the functionalized porous material is free of the labile ligand. In other words, the labile ligand can be completely replaced by the functionalizing agent. Moreover, the functionalized porous material can be free of open metal sites as the open metal sites are coordinated with the functionalizing agent. In an aspect, all the open metal sites in the functionalized porous structure are coordinated with the functionalizing agent.

This process enables the manufacture of functionalized porous materials with much greater efficiency in terms of time, cost, and waste as compared to known processes. Furthermore, this process is applicable to a range of different types of porous materials and ligand types, enabling manufacturing processes to be designed or improved upon for many different products.

The functionalized porous material manufactured by the process as described herein can have similar or improved performance as compared to the functionalized porous materials made by other known processes, and can be used in applications such as CO₂ sequestration, gas separation and storage, and catalysis.

The process of functionalizing a porous material is further illustrated by the following non-limiting examples.

### EXAMPLES

### General Procedure to Prepare Base MOF

The organic bridging ligand is stirred with a base for 15 min. A magnesium salt dissolved in water is then added to this slurry, and the resulting mixture is heated to reflux with vigorous stirring for 1 h. Water is then added to quench the reaction mixture, and the resulting slurry is filtered and washed with water to remove impurities. The resulting solid is briefly dried via flow of nitrogen, yielding material referred to as the “wet base MOF”, which is collected from the filtration apparatus.

### Example 1

Wet base MOF and a diamine were mixed until they reached a slurry of uniform consistency within a glass round-bottomed flask. The flask was attached to a rotary evaporator and heated to 80° C. with gentle rotation. Most of the water was removed at a set pressure of 150 mbar to avoid bumping (bubbling up into the apparatus). The pressure was slowly reduced to 12 mbar to remove water until the resulting material was dry.

### Example 2

Wet base MOF and a diamine were mixed until they reached a slurry of uniform consistency within a large bucket. Material was allowed to evaporate at room temperature (23° C.) and atmospheric pressure until dry.

### Example 3

Wet base MOF and a diamine were mixed until they reached a slurry of uniform consistency within a large glass crystallization dish. Material was heated to 110° C. while held at a pressure of 12 mbar until dry.

### Example 4

Wet base MOF and a diamine were mixed until they reached a slurry of uniform consistency within a large bucket. The resulting slurry was poured into stainless steel trays, which were placed in a vacuum oven. Material was heated to 65° C. while held at a pressure of 150 mbar under a slow purge of nitrogen gas until dry.

### Example 5

Wet base MOF and a diamine were mixed until they reached a slurry of uniform consistency within a glass round-bottomed flask. The flask was attached to a rotary evaporator and heated to 80° C. with gentle rotation. Most of the water was removed at a set pressure of 150 mbar to avoid bumping (bubbling up into the apparatus). The pressure was slowly reduced to 12 mbar to remove water until the resulting material was dry.

### Example 6

Wet base MOF and a diamine were mixed until they reached a slurry of uniform consistency within a glass round-bottomed flask. The flask was attached to a rotary evaporator and heated to 80° C. with gentle rotation. Most of the water was removed at a set pressure of 150 mbar to avoid bumping (bubbling up into the apparatus). The pressure was slowly reduced to 12 mbar to remove water until the resulting material was dry.

### Example 7

Wet base MOF and diamine were mixed until they reached a uniform consistency within a large glass crystallization dish. Material was heated to 40° C. while held at a pressure of 150 mbar under a slow purge of nitrogen gas until dry.

The conditions of Example 1 to Example 7 are summarized in the Table.

| | Ex 1 | Ex 2 | Ex 3 | Ex 4 | Ex 5 | Ex 6 | Ex 7 |
|---|---|---|---|---|---|---|---|
| Ligand 1 | diamine | diamine | diamine | diamine | diamine | diamine | diamine |
| Ligand 2 | water | water | water | water | water | water | methanol |
| Temp. | 80 | 23 | 110 | 65 | 80 | 80 | 40 |
| (° C.) | | | | | | | |
| Ligand 2/ | 7/1 | 7/1 | 7/1 | 7/1 | 20/1 | 7/1 | 7/1 |
| MOF | | | | | | | |
| (kg/kg) | | | | | | | |
| Ligand 1/ | 1.5 | 1.5 | 1.5 | 1.5 | 1.5 | 1 | 1.5 |
| metal sites | | | | | | | |
| (mol/mol) | | | | | | | |
| Slurrying | 10 | 10 | 5 | 10 | 5 | 10 | 10 |
| time (min) | | | | | | | |
| Vacuum | 12 | 1013.2* | 12 | 150** | 12 | 12 | 150 |
| (mbar) | | | | | | | |
| Equipment | rotavap | bucket | vacuum | vacuum | rotavap | rotavap | vacuum |
| | | | oven | oven | | | oven |

Base MOF used in the examples is Mg₂(dobpdc)
rotavap: rotary evaporator
*atmospheric pressure
**150 mbar with inert nitrogen purge

### Characterization of the Functionalized MOF Prepared in Examples 1-7

Thermogravimetric analysis was used to determine the 100% CO₂ adsorption isobar data for functionalized MOF synthesized via the processes described in Examples 1-7 and the functionalized MOF synthesized via a “state-of-the-art” solution-based method. The results indicate that the functionalized MOF materials made from a process as described herein have comparable CO₂ adsorption/desorption performance as compared to the baseline material.

Set forth are various aspects of the disclosure.

Aspect 1. A process of manufacturing a functionalized porous material, the process comprising: mixing a base porous material comprising a porous structure and a labile ligand with a functionalizing agent to form a slurry, the porous structure having open metal sites and a plurality of pores, wherein the labile ligand is coordinated to the open metal sites, present in the plurality of pores but not coordinated to the open metal sites, or a combination thereof, the labile ligand has a first boiling temperature and the functionalizing agent has a second boiling temperature that is higher than the first boiling temperature; and drying the slurry to form a functionalized porous material comprising the functionalizing agent coordinated to the open metal sites.

Aspect 2. The process as in any prior aspect, wherein the porous material is a metal-organic framework material.

Aspect 3. The process as in any prior aspect, wherein the second boiling temperature is about 50° C. to about 150° C. higher than the first boiling temperature.

Aspect 4. The process as in any prior aspect, wherein the labile ligand comprises at least one of water, methanol, ethanol, acetonitrile, or N,N-dimethylformamide.

Aspect 5. The process as in any prior aspect, wherein the labile ligand in the base porous material comprises greater than about 50 wt % of methanol, ethanol, or a combination thereof, based on a total weight of the labile ligand.

Aspect 6. The process as in any prior aspect, wherein the labile ligand in the base porous material comprises greater than about 50 wt % of water, based on a total weight of the labile ligand.

Aspect 7. The process as in any prior aspect, wherein the functionalizing agent comprises at least one of a monoamine, a diamine, a polyamine, or a bifunctional ligand.

Aspect 8. The process as in any prior aspect, wherein the open metal sites comprise ions of at least one of Mg, Ca, Ba, Al, Sc, Zr, V, Cr, Mn, Fe, Co, Ni, Cu, Zn, Ti, Cd, or Eu.

Aspect 9. The process as in any prior aspect, wherein the mixing is conducted in the presence of a slurry solvent.

Aspect 10. The process as in any prior aspect, wherein the mixing is conducted in the absence of a solvent.

Aspect 11. The process as in any prior aspect, wherein the slurry is dried at a temperature of about 20° C. to about 150° C. and a pressure of about 101,325 pascals to about 100 pascals to form the functionalized porous material.

Aspect 12. The process as in any prior aspect, wherein the slurry is dried at a temperature of about 40° C. to about 110° C. and a pressure of about 15,000 pascals to about 1,200 pascals to form the functionalized porous material.

Aspect 13. The process as in any prior aspect, wherein a weight ratio of the labile ligand relative to the porous structure is about 25:1 to about 0.5:1.

Aspect 14. The process as in any prior aspect, wherein a molar ratio of the functionalizing agent relative to the open metal sites in the base porous material is about 3:1 to about 1:1.

Aspect 15. The process as in any prior aspect, wherein a content of the labile ligand in the functionalized porous material is less than 40 wt % or less than 10 wt %, based on a total weight of the functionalized porous material.

Aspect 16. The process as in any prior aspect, further comprising preparing the base porous material by a reaction of a metal salt with an organic bridging ligand in the presence of a reaction solvent comprising the labile ligand.

Aspect 17. The process as in any prior aspect comprising: (a) a reaction of a metal salt with an organic bridging ligand in the presence of a reaction solvent comprising the labile ligand to form a crude product; (b) addition of water and/or other labile ligand to the crude product to obtain a quenched product; (c) filtration of the quenched product to obtain a filter cake; (d) rinsing of the filter cake to obtain a rinsed filter cake comprising the base porous material; (e) mixing of the rinsed filter cake with the functionalizing agent to form a slurry; and (f) drying of the slurry to form the functionalized porous material comprising the functionalizing agent coordinated to the open metal sites.

Aspect 18. The process as in any prior aspect, wherein a slurry solvent is combined with the rinsed filter cake and the functionalizing agent so that the rinsed filter cake and the functionalizing agent are mixed in the presence of the slurry solvent to form the slurry.

Aspect 19. The process as in any prior aspect, wherein no solvent is added to the rinsed filter cake or the functionalizing agent, and the rinsed filter cake and the functionalizing agent are mixed in the absence of any added solvent to form the slurry.

Aspect 20. The process as in any prior aspect, wherein the open metal sites comprise magnesium ions; and the organic bridging ligand comprises 4,4′-dioxidobiphenyl-3,3′-dicarboxylic acid.

Aspect 21. The process as in any prior aspect, wherein the slurry is dried at a temperature of about 20° C. to about 150° C. and a pressure of about 101,325 pascals to about 100 pascals.

Aspect 22. The process as in any prior aspect, wherein the labile ligand in the base porous material comprises greater than about 50 wt % of water based on a total weight of the labile ligand.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% or 5%, or 2% of a given value.

Unless defined otherwise, technical and scientific terms used herein have the same meaning as is commonly understood by one of skill in the art to which this invention belongs.

All references cited herein are incorporated by reference in their entirety. While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A process of manufacturing a functionalized porous material, the process comprising:
mixing a base porous material comprising a porous structure and a labile ligand with a functionalizing agent to form a slurry,
the porous structure having open metal sites and a plurality of pores,
wherein the labile ligand is coordinated to the open metal sites, present in the plurality of pores but not coordinated to the open metal sites, or a combination thereof,
the labile ligand has a first boiling temperature and the functionalizing agent has a second boiling temperature that is higher than the first boiling temperature; and
drying the slurry to form a functionalized porous material comprising the functionalizing agent coordinated to the open metal sites.

2. The process of claim 1, wherein the porous material is a metal-organic framework material.

3. The process of claim 1, wherein the second boiling temperature is about 50° C. to about 150° C. higher than the first boiling temperature.

4. The process of claim 1, wherein the labile ligand comprises at least one of water, methanol, ethanol, acetonitrile, or N,N-dimethylformamide.

5. The process of claim 1, wherein the labile ligand in the base porous material comprises greater than about 50 wt % of methanol, ethanol, or a combination thereof, based on a total weight of the labile ligand.

6. The process of claim 1, wherein the labile ligand in the base porous material comprises greater than about 50 wt % of water, based on a total weight of the labile ligand.

7. The process of claim 1, wherein the functionalizing agent comprises at least one of a monoamine, a diamine, a polyamine, or a bifunctional ligand.

8. The process of claim 1, wherein the open metal sites comprise ions of at least one of Mg, Ca, Ba, Al, Sc, Zr, V, Cr, Mn, Fe, Co, Ni, Cu, Zn, Ti, Cd, or Eu.

9. The process of claim 1, wherein the mixing is conducted in the presence of a slurry solvent.

10. The process of claim 1, wherein the mixing is conducted in the absence of a solvent.

11. The process of claim 1, wherein the slurry is dried at a temperature of about 20° C. to about 150° C. and a pressure of about 101,325 pascals to about 100 pascals to form the functionalized porous material.

12. The process of claim 1, wherein the slurry is dried at a temperature of about 40° C. to about 110° C. and a pressure of about 15,000 pascals to about 1,200 pascals to form the functionalized porous material.

13. The process of claim 1, wherein a weight ratio of the labile ligand relative to the porous structure is about 25:1 to about 0.5:1.

14. The process of claim 1, wherein a molar ratio of the functionalizing agent relative to the open metal sites in the base porous material is about 3:1 to about 1:1.

15. The process of claim 1, wherein a content of the labile ligand in the functionalized porous material is less than 40 wt %, based on a total weight of the functionalized porous material.

16. The process of claim 1, further comprising preparing the base porous material by a reaction of a metal salt with an organic bridging ligand in the presence of a reaction solvent comprising the labile ligand.

17. The process of claim 1 comprising:
(a) a reaction of a metal salt with an organic bridging ligand in the presence of a reaction solvent comprising the labile ligand to form a crude product;
(b) addition of water or other labile ligand to the crude product to obtain a quenched product;
(c) filtration of the quenched product to obtain a filter cake;
(d) rinsing of the filter cake to obtain a rinsed filter cake comprising the base porous material;
(e) mixing of the rinsed filter cake with the functionalizing agent to form a slurry; and
(f) drying of the slurry to form the functionalized porous material comprising the functionalizing agent coordinated to the open metal sites.

18. The process of claim 17, wherein a slurry solvent is combined with the rinsed filter cake and the functionalizing agent so that the rinsed filter cake and the functionalizing agent are mixed in the presence of the slurry solvent to form the slurry.

19. The process of claim 17, wherein no solvent is added to the rinsed filter cake or the functionalizing agent, and the rinsed filter cake and the functionalizing agent are mixed in the absence of any added solvent to form the slurry.

20. The process of claim 17, wherein the open metal sites comprise magnesium ions; and the organic bridging ligand comprises 4,4′-dioxidobiphenyl-3,3′-dicarboxylic acid.

21. The process of claim 17, wherein the slurry is dried at a temperature of about 20° C. to about 150° C. and a pressure of about 101,325 pascals to about 100 pascals.
